(19) United States
(12) Patent Application Publication
(10) Pub. No.: US 2009/0250833 A1
(43) Pub. Date: Oct. 8, 2009

(54) PROCESSES FOR PRODUCING POLYURETHANE MOLDINGS

(75) Inventors: Karsten Muller, Leverkusen (DE); Detlef Mies, Elsdorf (DE); Ulrich Kramer, Sommerda (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/365,932

(22) Filed: Feb. 5, 2009

(30) Foreign Application Priority Data
Feb. 9, 2008 (DE) 102008008390.9

(51) Int. Cl. B29C 41/20

(52) U.S. Cl. 264/135

(57) ABSTRACT

Processes comprising: providing a mold; providing an insert having a shape such that it fits exactly into the mold, and applying one or more layers selected from top coats and films (A) to the insert; placing the insert into the mold; introducing a polyurethane reactive mixture (D) into the insert; curing the polyurethane reactive mixture to form a polyurethane molding; and removing the polyurethane molding and insert from the mold.

### BACKGROUND OF THE INVENTION

Polyurethane moldings have generally been produced by, for example, introducing (injecting) an IMC paint (in-mold coating paint) into a preferably polished mold. After a certain period for evaporation of solvent from the paint (surface-drying of the paint), the polyurethane reaction mixture or a polyurethane-glass fibre mixture is introduced into the mold. The mold is closed and, after an appropriate cure time, the component is removed. Disadvantages of these processes are the high mold costs and the long cycle times, due among other things to the time-consuming cleaning of the mold. In addition, the mold surface is very sensitive so that in the event of damage, high repair costs and loss of production result. Continuous wear also causes high repair costs and short consecutive maintenance intervals, together with correspondingly long downtimes.

Because of the disadvantages described above, in particular medium to large production runs or the production of components with large surface areas, in particular components with complex, multi-layer PUR construction as well as those having an IMC, are very difficult to achieve economically.

### BRIEF SUMMARY OF THE INVENTION

The present invention relates, in general, to processes for the production of polyurethane moldings of complex construction with optically demanding surfaces. The various embodiments of the present invention provide processes which do not exhibit the aforementioned disadvantages.

Surprisingly, it has now been found that the disadvantages of the prior art can be avoided by processes employing a mold with a removable insert. The insert has the same contours as the mold and is placed into said mold with an exact fit.

The present invention includes processes for the production of polyurethane moldings, wherein
i) a mold is presented,
ii) a top coat, for example an IMC paint or an IMC coat (in-mold decoration) and/or a film A) is injected, sprayed, inserted or introduced into an insert which fits exactly into the mold,
iii) optionally a functional coat B), preferably consisting of a polyurethane reactive mixture, is applied, preferably sprayed, on to the top coat or film A),
iiv) optionally further PUR coats C) are applied on to the functional coat B),
iv) the insert is placed into the mold,
vi) a polyurethane reactive mixture D) is introduced into the insert positioned in the mold,
vii) the polyurethane mixture is cured,
viii) the insert with the polyurethane molding is removed from the mold.

One embodiment of the present invention includes a process comprising:
(i) providing a mold;
(ii) providing an insert having a shape such that it fits exactly into the mold, and applying one or more layers selected from top coats and films (A) to the insert;
(v) placing the insert into the mold;
(vi) introducing a polyurethane reactive mixture (D) into the insert;
(vii) curing the polyurethane reactive mixture to form a polyurethane molding; and
(viii) removing the polyurethane molding and insert from the mold.

Advantages of the processes according to the invention include the fact that, among other things, mold inserts, especially polished mold inserts, are used. On the one hand mold inserts are cheaper, so that in the event of damage it is not necessary to repair or replace the entire, expensive mold; furthermore, the time during which the mold is available is significantly increased as a result.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a polyurethane reactive mixture (D)” herein or in the appended claims can refer to a single a polyurethane reactive mixture (D) or more than one a polyurethane reactive mixture (D). Additionally, all numerical values, unless otherwise specifically noted, are understood to be modified by the word “about.”

It is also possible to use several mold inserts in parallel. The application of the IMC paint or the insertion of the film and, where necessary, the introduction of various polyurethane (PUR) layers and reinforcing materials can take place outside the actual mold, so that the cycle times in which the complete molding is produced can be reduced. Furthermore, the application of the IMC paint and the introduction of PUR spray coats can take place in a spray booth, which ensures an additional increase in cleanliness. The top part of the mold can also be provided with appropriate mold release agents without the risk of contaminating the insert.

Another advantage is that, at the time of introducing the material, the insert does not have to be at the mold temperature, which means that it is possible to use reactive, temperature-initiated PUR systems which react rapidly after introduction of the insert into the hot mold, thus reducing the cycle time further. It is optionally also possible to introduce bilaterally glass fibre-reinforced, PUR-wetted sandwich elements into the insert outside the mold.

In principle, it is possible to produce complex components in short cycle times by means of the process according to the invention, since previously essential process steps can be dissociated from the mold and can take place in parallel.

The insert can be introduced into the mold for example using a shuttle system or by means of a PUR input robot in conjunction with an appropriate adaptor system.

The PUR coats C) can also contain reinforcing materials. It is preferred to use as coat C) a bilaterally glass fibre-reinforced, PUR-wetted sandwich element with a core layer, wherein the core layer is preferably a paper, metal or plastic honeycomb.

The PUR reactive mixture D) can be introduced either by an open filling method or by means of injection into the closed mold (RIM process).

The top part of the mold can, if necessary, be provided with mold release agents.

After the insert with the finished PUR molding has been removed, another insert which has already been prepared in accordance with the steps ii) to iv) described above can be placed into the mold immediately.

Suitable materials for the mold insert are all materials which exhibit the required surface quality and strength. Particularly suitable are steel or corresponding high-strength alloys. The selected material should have a coefficient of expansion adapted to that of the mold. The material should possess good thermal conductivity in order to be able to transfer the mold temperature to the material coats introduced within a brief interval and to dissipate the energy of the exothermic reaction to the mold rapidly. The material thickness of the inserts should be between 0.5 mm and 5 mm, preferably between 0.7 mm and 3 mm, particularly preferably between 1.5 mm and 2.0 mm

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(i) providing a mold;
(ii) providing an insert having a shape such that it fits exactly into the mold, and applying one or more layers selected from top coats and films (A) to the insert;
(v) placing the insert into the mold;
(vi) introducing a polyurethane reactive mixture (D) into the insert;
(vii) curing the polyurethane reactive mixture to form a polyurethane molding; and
(viii) removing the polyurethane molding and insert from the mold.

2. The process according to claim 1, further comprising (iii) applying a functional coat (B) to the one or more layers.

3. The process according to claim 2, wherein the functional coat (B) comprises a second polyurethane reactive mixture which may be the same or different from the polyurethane reactive mixture (D).

4. The process according to claim 2, wherein applying the functional coat (B) comprises spraying.

5. The process according to claim 2, further comprising (iv) applying a further PUR coat (C) to the functional coat (B).
